(19) United States
(12) Patent Application Publication
(10) Pub. No.: US 2015/0138390 A1
(43) Pub. Date: May 21, 2015

(54) IMAGE PROCESSING APPARATUS, IMAGING APPARATUS, METHOD FOR CONTROLLING IMAGE PROCESSING APPARATUS, AND STORAGE MEDIUM FOR PROVIDING FOCUS AND/OR EXPOSURE ADJUSTMENT CONTROL

(71) Applicant: CANON KABUSHIKI KAISHA, Tokyo (JP)

(72) Inventor: Toshihiko Tomosada, Kawasaki-shi (JP)

(21) Appl. No.: 14/549,319

(22) Filed: Nov. 20, 2014

(30) Foreign Application Priority Data
Nov. 21, 2013 (JP) 2013-240992

(51) Int. Cl. H04N 5/232

(52) U.S. Cl. CPC H04N 5/23229; H04N 5/23212
USPC 348/222.1

(57) ABSTRACT

An image processing apparatus includes a selection unit configured to select a main object area from among a plurality of object areas of an image in which any one of a plurality of object types is assigned to each of the object areas, a detection unit configured to detect a position and a size of each of the plurality of object areas, and a setting unit configured to set an evaluation area for obtaining an evaluation signal used for a predetermined control based on the main object area selected by the selection unit. The selection unit selects the main object area from among the plurality of object areas based on the position, size, and a priority set for each of the object types, of each of the plurality of object areas.

### BACKGROUND OF THE INVENTION

1. Field of the Invention

The present invention relates to an image processing apparatus in which a main object area to be used for a focus adjustment control and/or an exposure adjustment control from an image can be set.

2. Description of the Related Art

An imaging apparatus such as a digital video camera obtains an evaluation value signal from an image signal and performs an automatic focus adjustment (AF) control and/or an automatic exposure adjustment (AE) control. In the case of the AF control, the evaluation value signal refers to an AF evaluation value indicating a contrast state of the image signal. In the case of the AE control, the evaluation value signal refers to a luminance signal indicating brightness of the image signal. In general, an evaluation area (such as a focus detection area and a light metering area) for obtaining such an evaluation value signal is often set near the center of a screen. If the imaging apparatus includes a face detection function, the evaluation area is typically set to a predetermined area corresponding to a detected face by priority. In such an imaging apparatus, in order to adjust focus and/or exposure to an object at an edge of the screen, the object needs to be framed to come near the center so that the object is included in the evaluation area. Alternatively, an operation to move the evaluation area to an arbitrary position or disable the face detection function is needed.

As a method for eliminating the need for such operations, Japanese Patent Application Laid-Open No. 2010-197968 discusses a method that includes detecting an area belonging to a main color component based on a frequency distribution of color components included in a captured image, determining the detected area to be an evaluation area corresponding to a main object, and performing an in-focus evaluation on the object.

The method discussed in Japanese Patent Application Laid-Open No. 2010-197968 is susceptible to the effect of composition because the areas (sizes) of objects in the captured image and the positions of the objects have a significant impact on the setting of the evaluation area. Depending on the sizes and positions of the objects, it may be difficult to set the evaluation area to an object intended by the user.

### SUMMARY OF THE INVENTION

The present invention is directed to a technique capable of setting an evaluation area to an object intended by the user without requiring complicated operations of the user.

According to an aspect of the present invention, an image processing apparatus includes, a selection unit configured to select a main object area from among object areas of an image in which any one of a plurality of object types is assigned to each of the object areas, a detection unit configured to detect a position and a size of each of the object areas, and a setting unit configured to set an evaluation area for obtaining an evaluation signal used for a predetermined control based on the main object area selected by the selection unit, wherein the selection unit is configured to select the main object area from among the object areas based on the position, size, and a priority set for each of the object types, of each of the object areas.

Further features of the present invention will become apparent from the following description of exemplary embodiments with reference to the attached drawings.

### BRIEF DESCRIPTION OF THE DRAWINGS

FIG. 1 is a block diagram illustrating a configuration of a video camera according to a first exemplary embodiment.

FIG. 2 is a conceptual diagram illustrating a priority setting table for determining a main object area according to the first exemplary embodiment.

FIG. 3 is a conceptual diagram illustrating a menu for specifying category-specific priorities according to the first exemplary embodiment.

FIG. 4 is a flowchart illustrating processing of a camera microcomputer according to the first exemplary embodiment.

FIG. 5 is a flowchart illustrating processing for calculating evaluation scores of respective divided areas according to the first exemplary embodiment.

FIG. 6 is a conceptual diagram illustrating a relationship between a distance from a barycenter of an area to a screen center, and an evaluation score according to the first exemplary embodiment.

FIG. 7 is a conceptual diagram illustrating a relationship between a size of an area and an evaluation score according to the first exemplary embodiment.

FIG. 8 is a flowchart illustrating processing for determining a main object area according to the first exemplary embodiment.

FIG. 9 is a block diagram illustrating a configuration of a video camera according to a second exemplary embodiment.

FIG. 10 is a flowchart illustrating processing of a camera microcomputer according to the second exemplary embodiment.

FIG. 11 is a block diagram illustrating a configuration of a video camera according to a third exemplary embodiment.

FIG. 12 is a flowchart illustrating processing of a camera microcomputer according to the third exemplary embodiment.

FIG. 13 is a flowchart illustrating processing for changing priorities according to a imaging condition according to the third exemplary embodiment.

FIG. 14 is a conceptual diagram illustrating a weighting factor table for changing the priorities according to the third exemplary embodiment.

### DESCRIPTION OF THE EMBODIMENTS

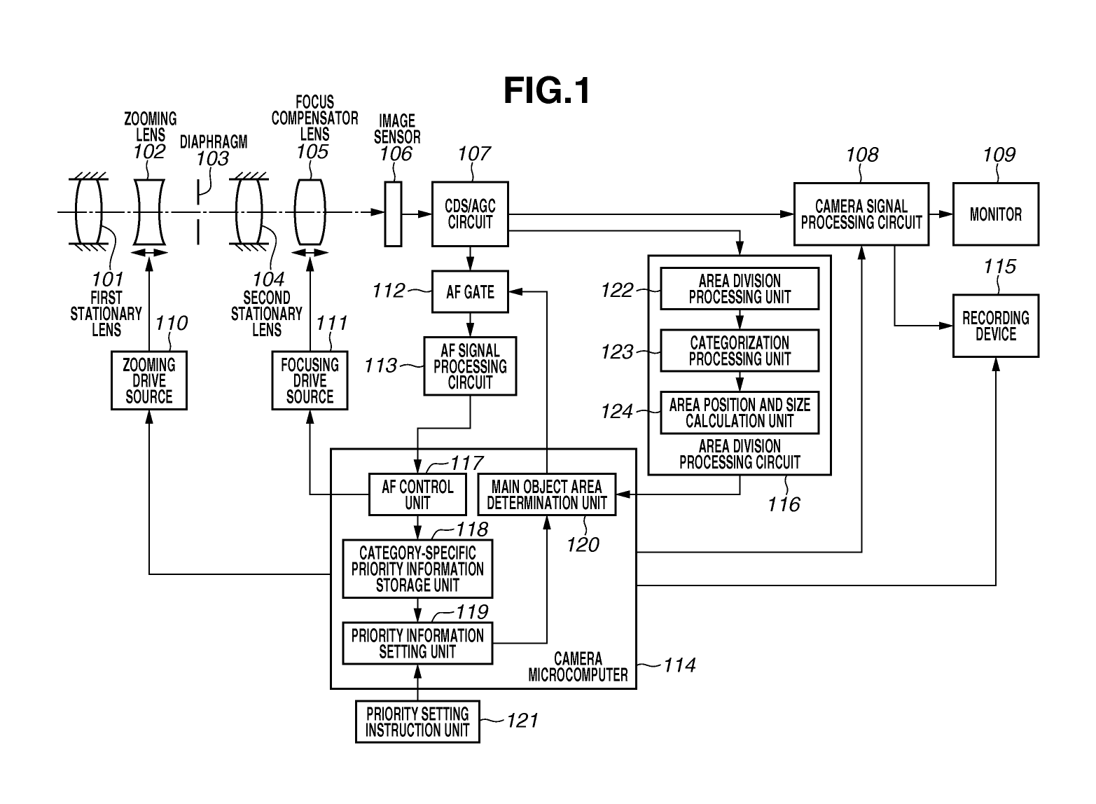

A first exemplary embodiment of the present invention will be described below. In the present exemplary embodiment, a camera that determines a main object area from a captured image and performs a focus adjustment based on an evaluation signal of an evaluation area, is described. FIG. 1 illustrates a configuration of a video camera (imaging apparatus) including an image processing apparatus according to the present exemplary embodiment. While the present exemplary embodiment deals with a video camera, an exemplary embodiment of the present invention may be applied to other imaging apparatuses such as a digital still camera.

In FIG. 1, a first stationary lens 101, a zooming lens 102, a diaphragm 103, a second stationary lens 104, and a focus compensator lens 105 constitute an imaging optical system for focusing light from an object. The zooming lens 102 moves in an optical axis direction to perform a zooming operation. The focus compensator lens (hereinafter, focusing lens) 105 has both a function of correcting a shift of a focal plane caused by zooming and a focusing function.

An image sensor 106 serving as a photoelectric conversion element includes a charge-coupled device (CCD) sensor or a complementary metal oxide semiconductor (CMOS) sensor. The light passed through the imaging optical system is focused on the image sensor 106 to form an object image, which the image sensor 106 photoelectrically converts to output an electrical signal. A correlated double sampling (CDS)/automatic gain control (AGC) circuit 107 samples the output of the image sensor 106 and adjusts gain. A camera signal processing circuit 108 applies various types of image processing to an output signal from the CDS/AGC circuit 107 to generate an imaging signal. A monitor 109 includes a liquid crystal display (LCD). The monitor 109 displays the imaging signal from the camera signal processing circuit 108. A recording device 115 records the imaging signal from the camera signal processing circuit 108 on a recording medium such as a magnetic tape, an optical disk, and a semiconductor memory.

A zooming drive source 110 is a zooming drive source for moving the zooming lens 102. A focusing drive source 111 is a drive source for moving the focusing lens 105. The zooming drive source 110 and the focusing drive source 111 each include an actuator such as a stepping motor, a direct-current (DC) motor, a vibratory motor, and a voice coil motor.

An AF gate 112 passes only a signal of an area used for focus detection (focus detection area) from the output signal of all pixels of the CDS/AGC circuit 107. In the present exemplary embodiment, the AF gate 112 sets an area detected by a main object area determination unit 120 to be described below as the focus detection area and passes a corresponding signal. An AF signal processing circuit 113 extracts a high frequency component and/or a luminance difference component (difference between maximum and minimum values of a luminance level of the signal passed through the AF gate 112) from the signal passed through the AF gate 112 to generate an AF evaluation value. The AF evaluation value generated by the AF signal processing circuit 113 is output to a camera microcomputer 114 serving as a control unit. The AF evaluation value indicates a contrast state of the image generated based on the output signal. Since the contrast state varies depending on a focus state (degree of focusing) of the imaging optical system, the AF evaluation value consequently serves as a signal for indicating the focus state of the imaging optical system. The camera microcomputer 114 serving as the control unit controls the operation of the entire video camera. An AF control unit 117 of the camera microcomputer 114 performs an AF control which includes controlling the focusing drive source 111 based on the AF evaluation value to move the focusing lens 105 for focus adjustment.

Next, an area division processing circuit 116 will be described. The area division processing circuit 116 according to the present exemplary embodiment includes an area division processing unit 122, a categorization processing unit 123, and an area position and size calculation unit 124. The area division processing unit 122 performs image processing for dividing an image into areas object by object based on feature amounts (for example, information about luminance components and color components, and boundary edges) of the output signal from the CDS/AGC circuit 107.

The output of the area division processing unit 122 is input to the categorization processing unit 123. The categorization processing unit 123 determines what object each of the divided areas is based on the feature amounts (for example, luminance components, color components, the shape of the area, and the position of the area in the image) detected during the area division processing, and categories the objects. The present exemplary embodiment describes an example where there are seven categories including “persons”, “nature (mountains and trees)”, “sky”, “buildings”, “flowers”, “cars”, and “others”. The types of the categories and the number of categories are not limited thereto. For example, the “persons” category may be subdivided into a “faces” category and a “bodies” category. The “cars” category and the “buildings” category may be combined into a broader “artificial objects” category.

The output of the categorization processing unit 123 is then input to the area position and size calculation unit 124. The area position and size calculation unit 124 calculates the centroid position and size (for example, the number of pixels) of each area divided by the area division processing unit 122. The calculation result is transmitted to the camera microcomputer 114.

The camera microcomputer 114 includes a category-specific priority information storage unit 118, a priority information setting unit 119, the main object area determination unit 120, and the AF control unit 117. The main object area determination unit 120 determines an area to be a main object from among the areas divided by the area division processing circuit 116 based on the centroid position and size of each of the divided areas and a priority of selection as a main object.

The priority of selection as a main object will be described in detail below. The priority is an index that indicates the degree of priority for an area to be selected as one to be a main object from among the areas divided by the area division processing circuit 116. The main object refers to an object to which the user who is capturing an image intends to adjust focus and exposure among the objects included in the imaging screen. For example, the priority is set as an evaluation score of zero to five points for each type of category. Instead of directly setting evaluation scores, the categories may be prioritized from first to seventh ranks, and evaluation scores may be set according to the ranking.

In the present exemplary embodiment, the priorities of the respective categories are determined in advance in terms of evaluation scores of zero to five points, taking into consideration the degree of certainty of being a main object based on the features (including at least one of an object distance, contrast, and exposure) of the object. The relationship between the types and priorities of the categories is defined as table data, which is stored in the category-specific priority information storage unit 118. For example, the user generally tends to capture near objects by priority. Objects with fewer features (lower contrast), like the sky and walls, tend to be captured less.

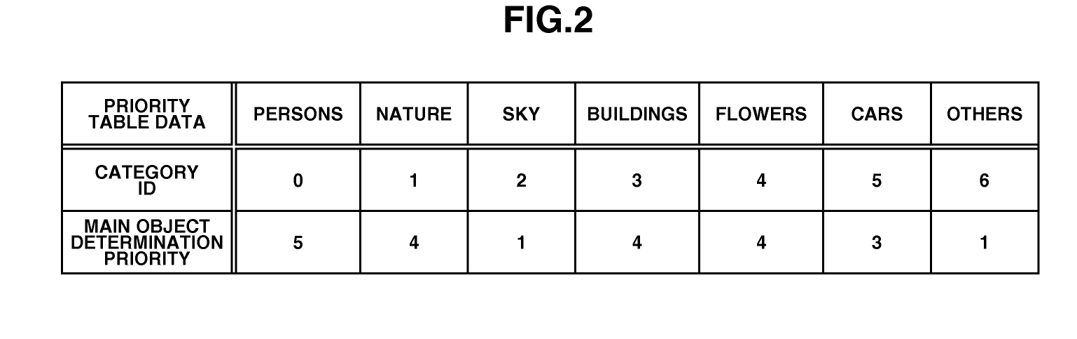

FIG. 2 illustrates an example of priorities set in advance based on such information. In FIG. 2, a category identifier (ID) is a number indicating the type of the category. In the present exemplary embodiment, values of 0 to 6 are set in order. In the example of FIG. 2, a priority of five points is set for the “persons” category in which the user is typically likely to focus on and capture an object as a main object. A priority of four points is set for the “nature” category, the “buildings” category, and the “flowers” category in which an object is second likely to be captured as a main object. A priority of one point is set for the “sky” category and the “others” category in which an object is estimated to be less likely to be focused on as a main object.

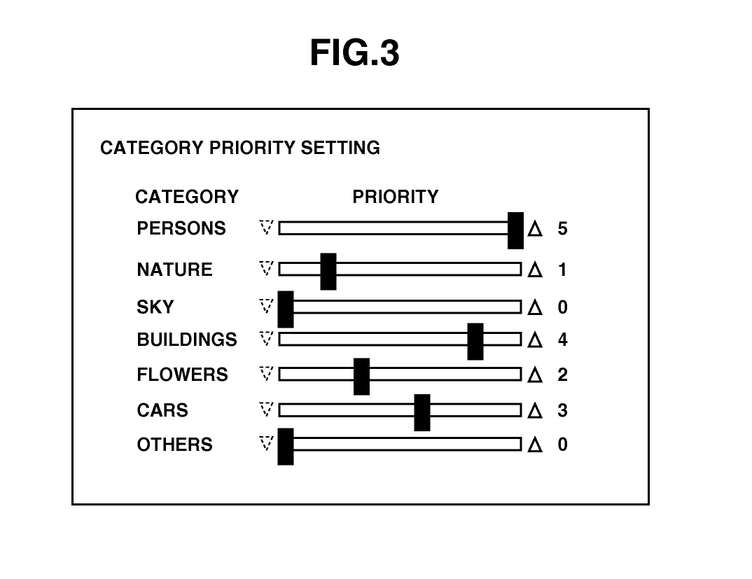

In addition to the priority table data described above, a priority setting instruction unit 121 may be provided by which the user can arbitrary set the priority of each category. For example, setting menus of the video camera may include a menu capable of setting priorities category by category such as illustrated in FIG. 3, from which the user specifies an evaluation score of zero to five points for each category. The provision of such a setting menu enables an object that the user wants to capture as a main object more to be automatically selected as a main object by priority.

The priority information setting unit 119 sets the table data stored in the category-specific priority information storage unit 118 or the evaluation scores of the respective categories specified by the priority setting instruction unit 121 as category-by-category priority information. In addition to the evaluation scores based on the category-by-category priority information, the main object area determination unit 120 sets evaluation scores based on the centroid positions and sizes of the respective divided areas. The main object area determination unit 120 adds the evaluation values at predetermined ratios, and determines an area of the category of which the evaluation score is the highest as a main object area. For example, the main object area determination unit 120 sets the evaluation scores according to distances from the screen center to the centroid positions of the divided areas so that divided areas closer to the screen center have higher evaluation scores. For example, the main object area determination unit 120 sets the evaluation scores according to the sizes of the divided areas so that greater areas have higher evaluation scores. A flow and details of the determination of a main object area will be described below. Based on the output result of the main object area determination unit 120, the camera microcomputer 114 transmits information to the AF gate 112 so that the focus detection area is set to the main object area in the imaging screen. The AF control unit 117 of the camera microcomputer 114 performs an AF control based on the AF evaluation value obtained through the AF gate 112.

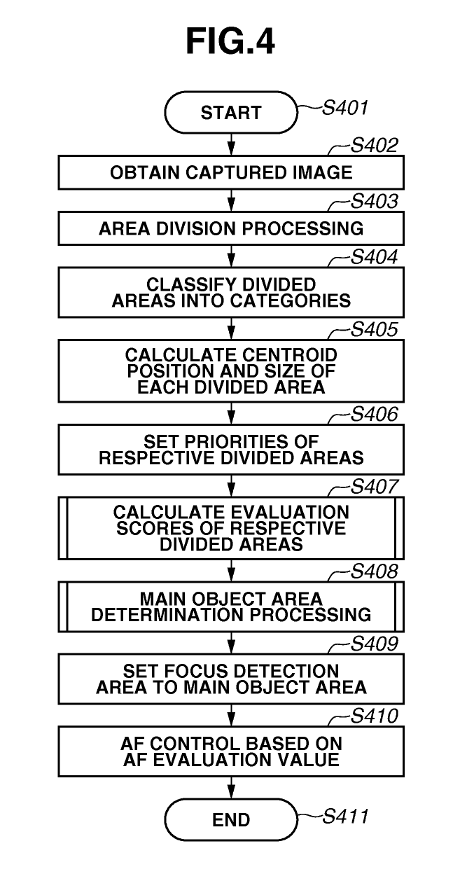

Next, the entire processing of the present exemplary embodiment will be described with reference to FIG. 4. FIG. 4 illustrates a flow of processing from the determination of a main object area from an image to the execution of an AF control. The processing is performed according to a computer program stored in the camera microcomputer 114. In step S401, the camera microcomputer 114 starts the processing.

In step S402, the camera microcomputer 114 obtains a captured image. The image to be obtained may be an image including all the pixels read from the image sensor 106, an image obtained by thinning the pixels, or a small-sized image obtained by reducing resolution.

In step S403, the camera microcomputer 114 passes the image obtained in step S402 through the area division processing unit 122 of the area division processing circuit 116 for image processing, whereby the image is divided into object areas. At that time, a structure array Object for storing the centroid positions, sizes, and category information to be described below of the respective divided areas is prepared. In the present exemplary embodiment, the number of elements of the structure array Object is the same as the number of divided areas. The structure array Object includes members such as a category ID number Category which indicates the type of the category of a divided area, an X coordinate PosX and a Y coordinate PosY of the centroid position of the area, a size “Size” of the area, a priority “Priority” of selection as a main object, and an evaluation score “Score” for determining a main object.

In step S404, the category classification processing unit 123 classifies the areas divided in step S403 based on the feature amounts of the image (for example, luminance components, color components, the shapes of the areas, and the positions of the areas in the image), and attaches information for identifying the types of the already-registered categories, such as an ID number and a tag, to the areas. The present exemplary embodiment describes an example where the categorization processing unit 123 classifies the areas into the seven categories “persons”, “nature (mountains and trees)”, “sky”, “buildings”, “flowers”, “cars”, and “others”, and attaches ID numbers of 0 to 6 thereto, respectively. However, the method is not limited thereto. The ID numbers of the classified categories are stored in Object[i].Category. The index i of the structure array Object takes values of 0 to (the number of divided areas−1), which indicate the ID numbers by which the divided areas can be distinguished.

In step S405, the area position and size calculation unit 124 calculates the centroid position PosX and PosY and the size “Size” of each area divided in step S403. The calculated centroid position PosX and PosY and size “Size” are stored in the structure array Object[i].Posx, Object[i].PosY, and Object[i].Size, respectively. The processing of steps S403 to S405 may be performed by a dedicated microcomputer for performing only the area division processing, different from the camera microcomputer 114. A hardware circuit may be configured to perform the area division processing.

In step S406, the priority information setting unit 119 reads the priority table data stored in the category-specific information storage unit 118 of the camera microcomputer 114. The priority information setting unit 119 then sets the priorities “Priority” into Object[i].Priority according to the category ID numbers Object[i].Category. Alternatively, the priority information setting unit 119 sets the category-specific priorities specified by the priority setting instruction unit 121 into Object[i].Priority.

In step S407, the main object area determination unit 120 calculates the evaluation scores of the respective divided areas for determining a main object area based on the centroid positions, sizes, and priorities of the areas. A flow of detailed operations of the processing performed in step S407 will be described below.

In step S408, the main object area determination unit 120 determines a main object area based on the evaluation scores calculated in step S407, and the processing proceeds to step S409. The operation of the processing (main object area determination processing) performed in step S408 will be described in detail below.

In step S409, the AF gate 112 sets the focus detection area for obtaining the AF evaluation value signal used for an AF control to the main object area determined in step S408. In the present exemplary embodiment, the camera microcomputer 114 transmits the centroid position Object[i].PosX and Object[i].PosY and the size Object[i].Size of the main object area determined in step S408 to the AF gate 112. As a result, the AF gate 112 sets a rectangular evaluation area as the focus detection area based on the centroid position and size. However, it is not limited thereto. For example, the AF gate 112 may set the focus detection area according to the shape of the main object area. A frame may be displayed or the boundary of the selected area may be highlighted to show the user which area is set as the focus detection area.

In step S410, the AF control unit 117 performs an AF control based on the AF evaluation value generated from the image signal of the focus detection area set in step S409. The processing proceeds to step S411 to end the processing. The AF control performed in step S410 is a typical contrast AF control. A detailed operation thereof will be omitted.

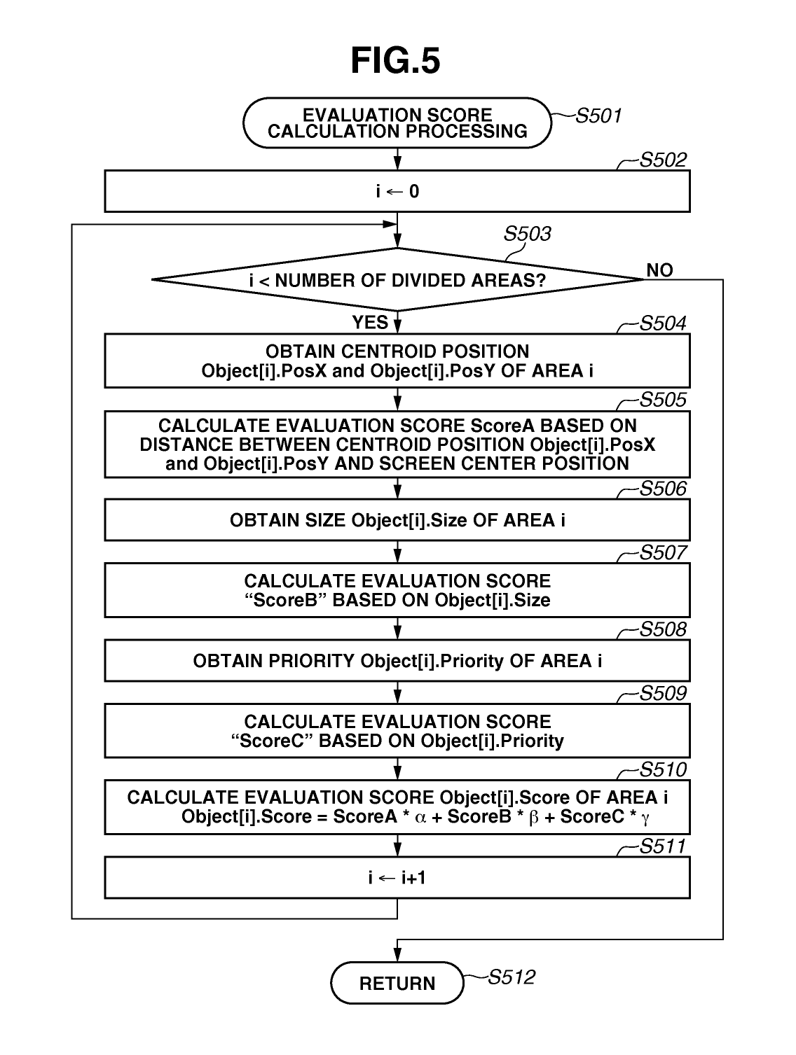

The processing for calculating the evaluation scores of the respective divided areas, performed in step S407, will be described in detail with reference to the flowchart of FIG. 5. This processing is performed according to a computer program stored in camera computer 114. In step S501, the main object area determination unit 120 starts the processing.

In step S502, the main object area determination unit 120 clears a counter i of an index used for loop processing performed in step S503 and subsequent steps to 0. In step S503, the main object area determination unit 120 determines whether the counter value i is smaller than the number of divided areas. If the counter value i is smaller (YES in step S503), the processing proceeds to step S504. If the counter value i is not smaller (NO in step S503), the main object area determination unit 120 skips the processing of step S410 and subsequent steps because the loop processing is completed. The processing proceeds to step S512 to end the processing.

In step S504, the main object area determination unit 120 obtains the centroid position Object[i].PosX and Object[i].PosY of each divided area calculated in step S405. In step S505, the main object area determination unit 120 calculates a centroid position-based evaluation score “ScoreA” based on a distance between the obtained centroid position of the area and a screen center position. The distance “Distance” between the centroid position (Object[i].PosX and Object[i].PosY) of the area and the screen center position (CenterPosX and CenterPosY) is calculated by formula 1:

Distance=√((Object[i].PosX−CenterPosX)²+(Object[i].PosY−CenterPosY)²) formula 1

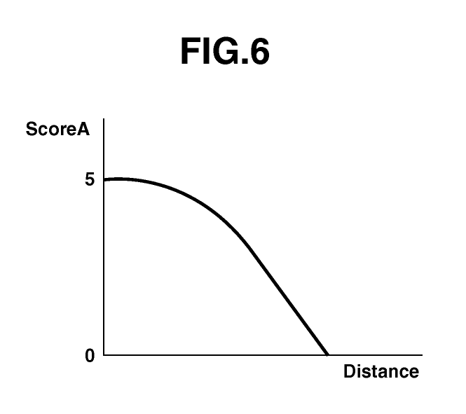

The distance “Distance” calculated by the foregoing formula indicates that the closer to 0, the closer the area is to the screen center. FIG. 6 is a graph in which the horizontal axis indicates the distance “Distance” and the vertical axis the evaluation score “ScoreA”. The main object area determination unit 120 calculates the evaluation score “ScoreA”, for example, by using a formula that is set in such a manner that the closer to the screen center, the higher the evaluation score “ScoreA” becomes as illustrated in FIG. 6. In the present exemplary embodiment, as illustrated in FIG. 6, the formula is set in such a manner that the evaluation score “ScoreA” does not change much if the centroid position of the area lies near the screen center, and the evaluation score “ScoreA” decreases as the centroid position becomes separated from the screen center. However, it is not limited thereto. For example, the formula may be set in such a manner that the evaluation score “ScoreA” falls sharply as the centroid position is separated from the screen center. The formula may be set so that the evaluation score “ScoreA” is proportional to the distance “Distance”. Instead of the formula, discrete table data associating the distance “Distance” with evaluation scores “ScoreA” may be provided, from which the main object area determination unit 120 may read an evaluation score “ScoreA” according to the distance “Distance”.

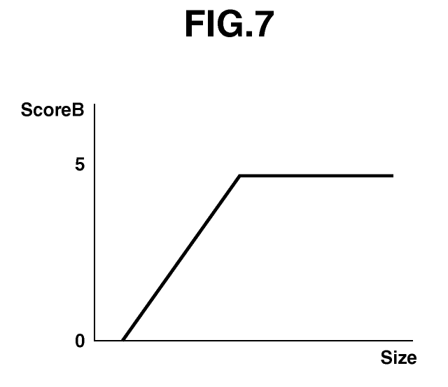

In step S506, the main object area determination unit 120 obtains the size Object[i].Size of each divided area calculated in step S405. In step S507, the main object area determination unit 120 calculates a size-based evaluation score “ScoreB” based on the obtained size Object[i].Size of the area. FIG. 7 is a graph in which the horizontal axis indicates the size “Size” of the area and the vertical axis the evaluation score “ScoreB”. The main object area determination unit 120 calculates the evaluation score “ScoreB” by using a formula that is set in such a manner that the evaluation score “ScoreB” increases with the increasing size “Size” and becomes constant at or above a predetermined size as illustrated in FIG. 7. Like the evaluation score “ScoreA”, the formula of the evaluation score “ScoreB” is not limited to the foregoing, and other formulas may be used. Discrete table data associating the size “Size” with evaluation scores “ScoreB” may be provided.

In step S508, the main object area determination unit 120 obtains the priority Object[i].Priority of each area set in step S406. In step S509, the main object area determination unit 120 calculates a priority-based evaluation score “ScoreC” based on the obtained priority Object[i].Priority of each area. In the present exemplary embodiment, the main object area determination unit 120, though not limited thereto, simply uses the value of the priority Object[i].Priority set in step S406 as the evaluation score “ScoreC”.

In step S510, the main object area determination unit 120 calculates an evaluation score (evaluation value) Object[i].Score to be used for determination in the main object area determination processing, based on the three evaluation scores calculated in steps S505, S507, and S509 by formula 2:

Object[i].Score=ScoreA*α+ScoreB*β+ScoreC*γ formula 2

Here, α, β, and γ by which the evaluation scores “ScoreA”, “ScoreB”, and “ScoreC” are multiplied, respectively, are weighting factors for determining which evaluation score to give a higher weight. For example, the weighting factors α, β, and γ may each take a value of 0.0 to 1.0. The weighting factors α, β, and γ may be determined so that the sum of the values α+β+γ is 1.0. In the present exemplary embodiment, each weighting factor takes a value of 0.0 to 1.0. To increase the weight of the category priority-based evaluation score “ScoreC”, the weighting factor γ is set to a highest value. The increased weight of the evaluation score “ScoreC” increases the evaluation scores Object[i].Score of areas having higher priorities as a main object even if the areas are not near the center of the screen or are small in size. Consequently, such areas are likely to be determined to be a main object area in the main object area determination processing to be described below, and an object intended by the user can be easily focused on regardless of the composition.

The method for calculating the evaluation score Object[i].Score is not limited to formula 2. For example, the evaluation score Object[i].Score may be determined by multiplying the evaluation scores “ScoreA”, “ScoreB”, and “ScoreC” as expressed by formula 3:

Object[i].Score=ScoreA*ScoreB*ScoreC formula 3

The evaluation score Object[i].Score may be determined by multiplying the sum of the centroid position-based evaluation score “ScoreA” and the size-based evaluation score “ScoreB” by the priority-based evaluation score “ScoreC” as expressed by formula 4:

Object[i].Score=(ScoreA+ScoreB)*ScoreC formula 4

In formulas 3 and 4, the evaluation scores “ScoreA”, “ScoreB”, and “ScoreC” may be multiplied by the respective weighting factors α, α, and γ in advance. In this way, the method for calculating the evaluation score Object[i].Score can be modified as appropriate so that the intended main object area is more likely to be determined.

In step S511, the main object area determination unit 120 increments the counter i and returns to step S503. With such processing, the main object area determination unit 120 calculates the evaluation score Object[i].Score to be used for determination in the main object area determination processing with respect to each divided area.

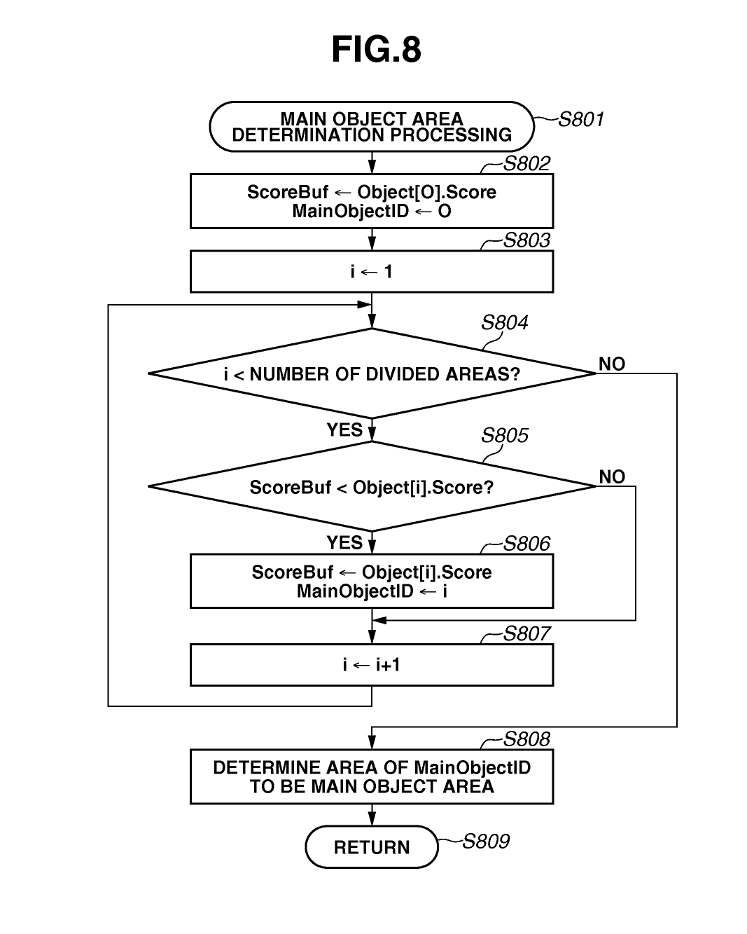

Next, the main object area determination processing performed in step S408 will be described in detail with reference to the flowchart of FIG. 8. This processing is performed according to a computer program stored in the camera microcomputer 114. In step S801, the main object area determination unit 120 starts the processing.

In step S802, the main object area determination unit 120 initializes an evaluation score buffer “ScoreBuf” to the evaluation score Object[0].Score of area 0. The evaluation score buffer “ScoreBuf” is intended to store the maximum evaluation score among the evaluation scores Object[i].Score of the respective divided areas. The main object area determination unit 120 initializes an ID number “MainObjectID” of an area to be a main object area to 0.

In step S803, the main object area determination unit 120 sets a counter i of an index used for loop processing performed in steps S804 and subsequent steps, to 1. In step S804, the main object area determination unit 120 determines whether the counter i is smaller than the number of divided areas. If the counter i is smaller (YES in step S804), the processing proceeds to step S805. If the counter i is not smaller (NO in step S804), the main object area determination unit 120 skips the processing of steps S805 to S807, and the processing proceeds to step S808 because the loop processing is completed.

In step S805, the main object area determination unit 120 compares the evaluation score buffer “ScoreBuf” with the evaluation score Object[i].Score of area i. If the evaluation score Object[i].Score of area i is higher (YES in step S805), the processing proceeds to step S806. If the evaluation score Object[i].Score of area i is not higher (NO in step S805), the main object area determination unit 120 skips the processing of step S806 and the processing proceeds to step S807.

In step S806, the main object area determination unit 120 updates the evaluation score buffer “ScoreBuf” with the evaluation score Object[i].Score of area i, and sets the ID number “MainObjectID” of the area to be a main object area, to i. In step S807, the main object area determination unit 120 increments the counter i, and the processing returns to step S804. The processing of steps S804 to S807 can be performed to determine the ID number of the area having the highest evaluation score among the divided areas.

In step S808, the main object area determination unit 120 determines the area having the ID number “MainObjectID” to be the main object area. The processing proceeds to step S809 to end the processing.

As described above, according to the present exemplary embodiment, a captured image is divided into areas object by object based on features. A main object area is then determined based on information about the centroid positions and sizes of the divided areas as well as the priority information that is set in advance according to the categories indicating the types of the objects. Consequently, an evaluation area such as a focus detection area can be set to an object area that the user is likely to be focusing attention on as a main object, regardless of the position of the object in the screen or the size of the object and without requiring complicated operations. The video camera can perform an AF control by using the signal of the evaluation area to adjust focus to the object intended by the user.

The first exemplary embodiment has described setting a focus detection area to the determined main object area and performing an AF control. A second exemplary embodiment will describe setting a light metering area intended for exposure adjustment to the main objet area and adjusting exposure by an AE control.

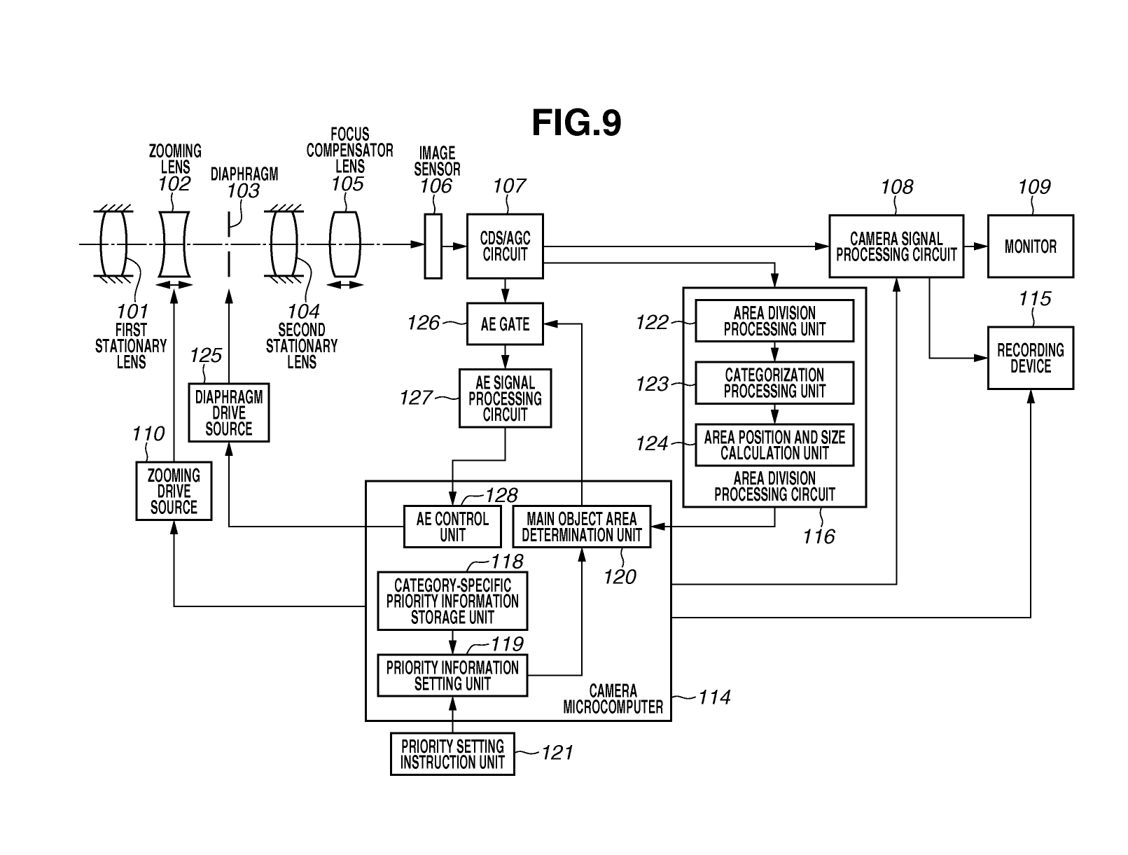

FIG. 9 illustrates a configuration of a video camera (imaging apparatus) including an image processing apparatus according to the present exemplary embodiment. In the present exemplary embodiment, the video camera will be described to include an AE gate 126 instead of the AF gate 112, an AE signal processing circuit 127 instead of the AF signal processing circuit 113, and an AE control unit 128 instead of the AF control unit 117. The video camera further includes a diaphragm drive source 125 for driving the diaphragm 103. However, similar to the configuration of the first exemplary embodiment, the video camera according to the present exemplary embodiment may also include the AF gate 112, the AF signal processing circuit 113, the AF control unit 117, and/or the focusing drive source 111. Other components are similar to those of the first exemplary embodiment. Similar components are designated by the same reference numerals as in the first exemplary embodiment.

The AE gate 126 passes only the signal of an area (light metering area) used for brightness detection from the output signal of all the pixels from the CDS/AGC circuit 107. The AE signal processing circuit 127 extracts a luminance component from the signal passed through the AE gate 126 to generate an AE evaluation value. The AE evaluation value is output to the camera microcomputer 114 serving as a control unit. The camera microcomputer 114 controls the operation of the entire video camera. The AE control unit 128 performs an AE control to adjust exposure based on the AE evaluation value.

The diaphragm drive source 125 includes an actuator and its driver for driving the diaphragm 103. To obtain a luminance value of the light metering area in the screen from the signal read by the CDS/AGC circuit 107, the AE signal processing circuit 127 obtains a light metering value and normalizes the light metering value by calculation. The AE control unit 128 then calculates a difference between the light metering value and a target value that is set to obtain appropriate exposure. The amount of correction drive of the diaphragm 103 is then calculated from the calculated difference. The AE control unit 128 controls driving of the diaphragm drive source 125 to change an aperture diameter of the diagraph 103 for exposure adjustment. In addition to controlling of the diaphragm drive source 125, the AE control unit 128 may adjust an exposure time of the image sensor 106 for exposure adjustment. The AE control unit 128 may control the CDS/AGC circuit 107 to adjust the level of the imaging signal for exposure adjustment.

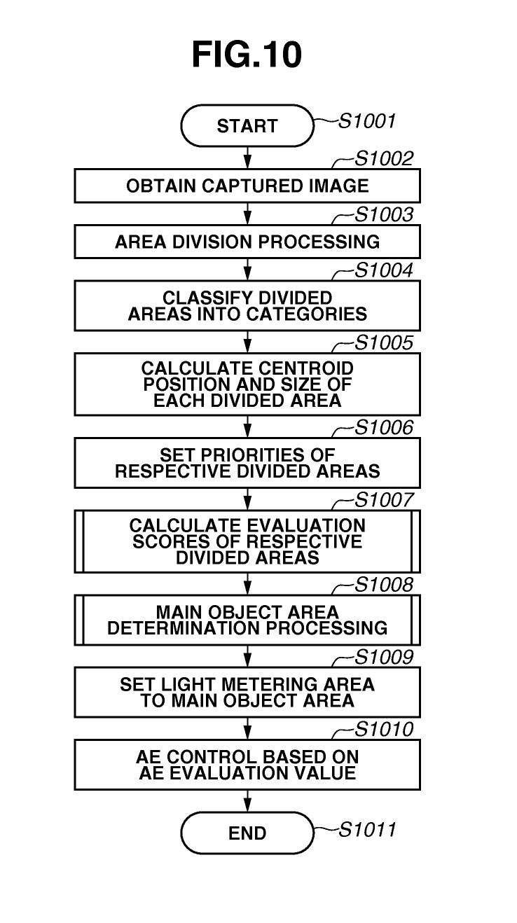

Next, a control flow according to the present exemplary embodiment will be described with reference to FIG. 10. This processing is performed according to a computer program stored in the camera microcomputer 114. The flow of FIG. 10 is basically similar to that of FIG. 4. To describe an AE control after the determination of the main object area, steps S1009 and S1010 are replaced with the setting of a light metering area and the AE control based on the AE evaluation value, respectively. The processing of the other steps S1001 to S1008 is similar to that of steps S401 to S408 of FIG. 4. A description thereof is thus omitted.

In step S1009, the AE gate 126 sets the light metering area for obtaining the AE evaluation value signal used for an AE control to the main object area determined in step S1008. In the present exemplary embodiment, the camera microcomputer 114 transmits the centroid position Object[i].PosX and Object[i].PosY and the size Object[i].Size of the main object area determined in step S1008 to the AE gate 126. Similar to the setting of the focus detection area in the first exemplary embodiment, a rectangular evaluation area based on the centroid position and size is thus set as the light metering area. However, it is not limited thereto. For example, the AE gate 126 may set the light metering area according to the shape of the main object area. Similar to the focus detection area of the first exemplary embodiment, a frame may be displayed or the boundary of the selected area may be highlighted to show the user which area is set as the light metering area.

In step S1010, the AE control unit 128 performs an AE control based on the AE evaluation value generated from the image signal of the light metering area set in step S1009. Then, the processing proceeds to S1010 to end the processing.

As described above, according to the present exemplary embodiment, the main object area determined by a method similar to the method for determining a main object area according to the first exemplary embodiment is applied to an exposure adjustment control. The video camera can thus perform an appropriate exposure adjustment on the object intended by the user. The main object area determined by the foregoing method may be applied to both a focus adjustment control and an exposure adjustment control. In addition to the focus adjustment control and the exposure adjustment control, the main object area may also be applied to a color adjustment control such as a white balance adjustment.

The first and second exemplary embodiments have described the case where a main object area is determined by using the priority information which is determined category by category in advance, and a focus adjustment control or an exposure adjustment control is performed based on the evaluation signal of the main object area. A third exemplary embodiment will describe a case where the priority information is changed when needed according to past imaging history information, a selected imaging mode, and a control state of the camera, so that a more appropriate main object area is determined by taking account of the user's intention at the time of image capturing.

Similar to the second exemplary embodiment, the third exemplary embodiment describes the case of performing an exposure adjustment control. However, the third exemplary embodiment is also applicable when performing a focus adjustment control like the first exemplary embodiment, when performing both a focus adjustment control and an exposure adjustment control, and when performing a color adjustment control.

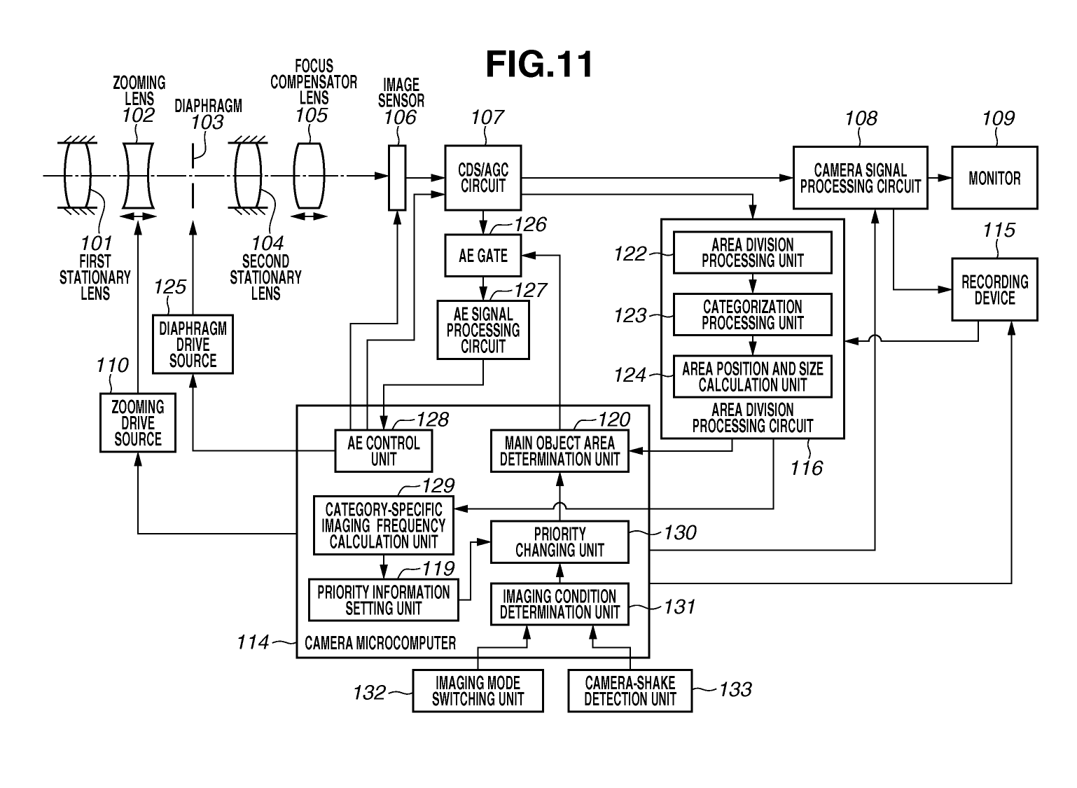

FIG. 11 illustrates a configuration of a video camera (imaging apparatus) including an image processing apparatus according to the present exemplary embodiment. The video camera according to the present exemplary embodiment has basically the same configuration as that of the second exemplary embodiment. The camera microcomputer 114 includes a category-specific imaging frequency calculation unit 129, a priority changing unit 130, and a imaging condition determination unit 131. The category-specific imaging frequency calculation unit 129 calculates imaging frequencies of the respective categories from image data recorded on the recording device 115. The priority changing unit 130 changes the priority information according to the imaging mode and the control state of the video camera. The imaging condition determination unit 131 determines a imaging condition including the imaging mode and the control state of the video camera. The camera microcomputer 114 further includes an imaging mode switching unit 132 and a camera-shake detection unit 133. The imaging mode switching unit 132 instructs the camera microcomputer 114 to switch the imaging mode. The camera-shake detection unit 133 is intended to detect a camera-shake state for determining whether the video camera is in a hand-held state or a panning state.

The category-specific imaging frequency calculation unit 129 analyzes the image data recorded on the recording device 115 and calculates the imaging frequencies category by category. In the present exemplary embodiment, the category-specific imaging frequency calculation unit 129 classifies the image data recorded on the recording device 115 into categories via the area division processing circuit 116. The category-specific imaging frequency calculation unit 129 then counts the numbers of times the categories are detected in a predetermined range of the screen, for example, a rectangular area near the screen center. The category-specific imaging frequency calculation unit 129 then calculates the numbers of times of detection of the respective categories to determine the imaging frequencies. Users typically tend to capture a main object in the center of the screen. The more frequently objects of a category are captured in the predetermined range in the screen center, the higher the priority is for the user to capture the objects classified as that category as a main object. Instead of analyzing the image data recorded on the recording device 115 to calculate the imaging frequencies, the category-specific imaging frequency calculation unit 129 may store the number of times object areas are determined to be a main object area by the main object area determination unit 120 at the time of image capturing category by category as a imaging history. The imaging frequency calculation unit 129 may store the imaging history in a not-illustrated memory, and calculate history information about the imaging history as the imaging frequencies.

The priority changing unit 130 multiplies the evaluation scores of the priorities set by the priority information setting unit 119 by predetermined weighting factors to change the evaluation scores according to the imaging condition determined by the imaging condition determination unit 131. The imaging condition determination unit 131 determines the imaging condition of the video camera, including the imaging mode switched by the imaging mode switching unit 132 to be described below, the camera-shake state detected by the camera-shake detection unit 133, and/or a focal length determined by the position of the zooming lens 102. The priority changing unit 130 then changes the priorities.

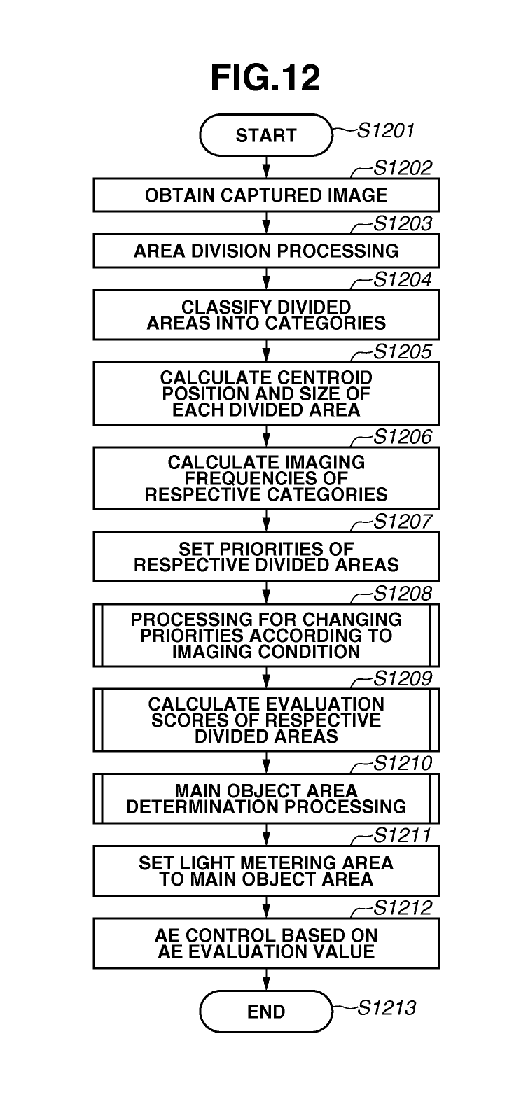

Next, a control flow according to the present exemplary embodiment will be described with reference to FIG. 12. This processing is performed according to a computer program stored in the camera microcomputer 114. The flow of FIG. 12 is basically similar to that of FIG. 10 except that the processing of step S1206 for calculating the imaging frequencies of the respective categories and the processing of step S1208 for changing the priorities according to the imaging condition are added. The processing of the other steps S1201 to S1205 and S1209 to S1213 is similar to that of steps S1001 to S1005 and S1007 to S1011 of FIG. 10. Descriptions thereof will be thus omitted.

The calculation of the imaging frequencies performed in step S1206 of FIG. 12 will be described. In the present exemplary embodiment, the image data recorded on the recording device 115 is divided into areas and classified into categories via the area division processing circuit 116. Based on the result of the division, the category-specific imaging frequency calculation unit 129 counts the numbers of times the categories are detected in the predetermined range in the screen center, and calculates the numbers of times of detection of the respective categories to determine the imaging frequencies. The processing for calculating the imaging frequencies may be applied to the entire image data recorded on the recording device 115. The processing may be limited to only part of the data, for example, image data of the same date. If the target image data is a moving image, it is difficult to calculate frequencies from the entire duration of one piece of moving image data. In such a case, the category-specific imaging frequency calculation unit 129 extracts a plurality of pieces of image data at predetermined time intervals and calculates the imaging frequencies based on the pieces of image data.

In step 1207, the priority information setting unit 119 sets the priorities (category-specific priority information “Priority”) in such a manner that the higher the imaging frequencies calculated in step S1206 are, the higher the priorities of the categories are. For example, the priority information setting unit 119 may sort the imaging frequencies in descending order, and set five, four, and three points to the top three categories and zero points to the other. Five points may be set to a category or categories having a predetermined imaging frequency or higher, and one point to a category or categories having lower imaging frequencies. Note that if the numbers of occurrence of the categories in the predetermined range of the screen are determined in such a manner, the “nature” category and the “sky” category may have high imaging frequencies because such objects are likely to be included as a background. Then, instead of the foregoing method, the number of times of selection as a main object area in the past may be stored category by category, and higher priorities may be given to categories of which the number of times is higher.

In step S1208, the priority changing unit 130 performs processing for changing the priorities set in step S1207 according to the imaging condition.

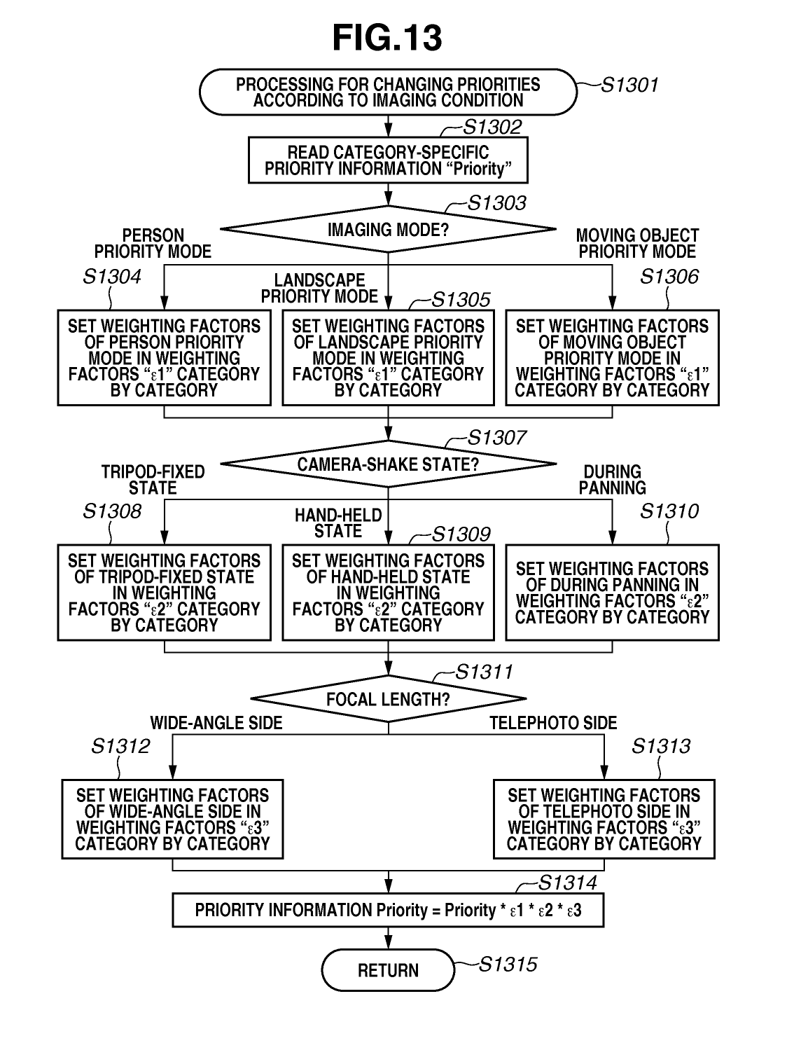

The processing for changing the priorities according to the imaging condition will be described in detail with reference to FIG. 13. This processing is performed according to a computer program stored in the camera microcomputer 114. In step S1301, the priority changing unit 130 starts the processing.

In step S1302, the priority changing unit 130 reads the category-specific priority information “Priority” set in step S1207 of FIG. 12. In step S1303, the priority changing unit 130 determines which the current imaging mode is, and the processing branches to one of steps S1304 to S1306 according to the imaging mode. The present exemplary embodiment describes a case where possible imaging modes include a “person priority mode” in which “persons” are selected as a main object by priority, a “landscape priority mode” in which a high priority is given to landscapes such as “nature” and “sky”, and a “moving object priority mode” in which a high priority is given to moving objects such as “persons” and “cars”. Other modes may also be included. Examples include a “flower priority mode” in which a high priority is given to “flowers” which is a subcategory of the “nature” category. In step S1303, if the imaging mode is determined to be the “person priority mode” (PERSON PRIORITY MODE in step S1303), the processing proceeds to step S1304. If the imaging mode is determined to be the “landscape priority mode” (LANDSCAPE PRIORITY MODE in step S1303), the processing proceeds to step S1305. If the imaging mode is determined to be the “moving object priority mode” (MOVING OBJECT PRIORITY MODE in step S1303), the processing proceeds to step S1306.

In step S1304, the priority changing unit 130 sets weighting factors of the “person priority mode” in weighting factors “ε1” according to the imaging mode. The weighting factors “ε1” according to the imaging mode are ones for the category-specific priority information “Priority” read in step S1302 to be multiplied by.

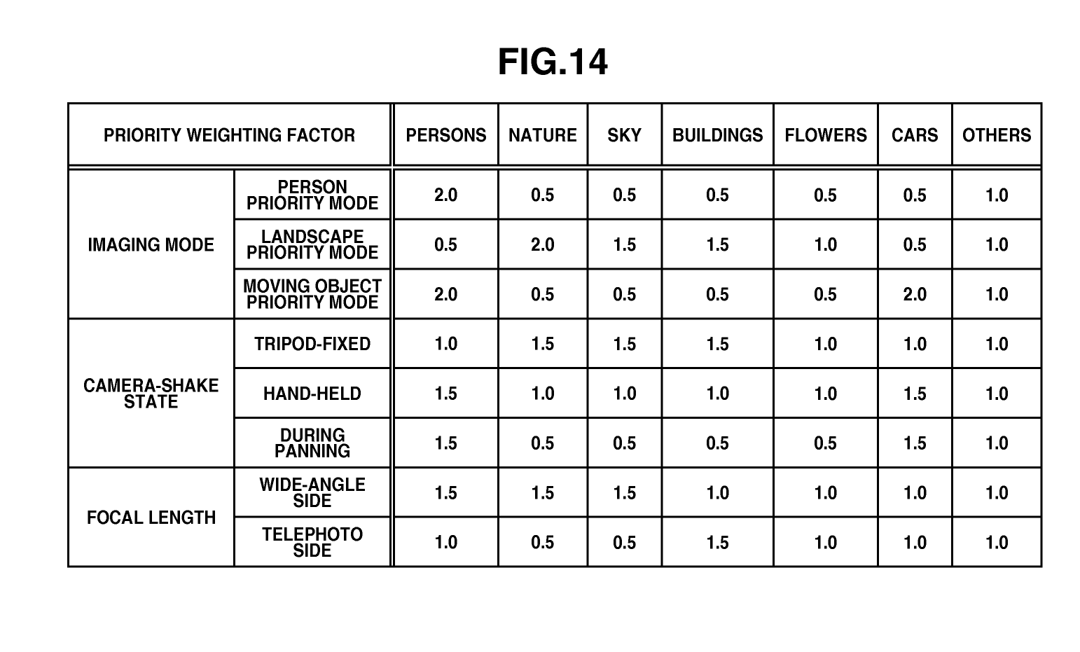

FIG. 14 illustrates an example of a weighting factor table for changing the priorities. In the present exemplary embodiment, as illustrated in FIG. 14, category-specific factor table data is determined in advance with respect to each imaging condition of the video camera, including the imaging mode, the camera-shake state, and the focal length. The priority changing unit 130 reads and sets the weighting factors from the category-specific factor table data. Since objects to give a high priority to in a selected imaging mode are determined in advance, the weighting factors according to the imaging mode are set to increase the priority of the corresponding category or categories.

Weighting factors according to the camera-shake state are set as follows. If the video camera is fixed on a tripod, the weighting factors are set to increase the priorities of the categories of stationary objects such as “nature” and “buildings” because the video camera is considered to be capturing an image at a fixed view angle. During hand-held imaging (camera-shake state) or during panning, the weighting factors are set to increase the priorities of the categories of moving objects such as “persons” and “cars” because the video camera is considered to be dynamically following and capturing an object.

Weighting factors according to the focal length are set as follows. The weighting factors on a wide-angle side are set to increase the priorities of “nature” and “buildings” because the video camera is estimated to be capturing a wide range. On the wide-angle side, the priority of “persons” is also set to be high because the video camera may be taking a wide-angle shot indoors. The settings of such weighting factors are not limited to the example of FIG. 14. Other settings may be used in consideration of the purpose of imaging.

Returning to FIG. 13, in step S1305, the priority changing unit 130 sets the weighting factors of the “landscape priority mode” in the weighting factors “ε1” according to the imaging mode. In step S1306, the priority changing unit 130 sets the weighting factors of the “moving object priority mode” in the weighting factors “ε1” according to the imaging mode.

In step S1307, the priority changing unit 130 determines the camera-shake state based on a detection result of the camera-shake detection unit 133, and the processing branches to one of steps S1308 to S1310 according to the camera-shake state. In the present exemplary embodiment, a case where there are three camera-shake states including a “tripod-fixed state”, a “hand-held state”, and “during panning”, is described. The “tripod-fixed state” refers to a state where no camera-shake is detected to occur and the video camera is determined to be fixed on a tripod. The “hand-held state” refers to a state where camera-shakes are detected and the video camera is determined to be held by hand for imaging. The “during panning” refers to a state where the direction of the video camera is determined to be being deliberately moved. The determination of the camera-shake state is not limited thereto. In step S1307, if the camera-shake state is determined to be the “tripod-fixed state” (TRIPOD-FIXED STATE in step S1307), the processing proceeds to step S1308. If the camera-shake state is determined to be the “hand-held state” (HAND-HELD STATE in step S1307), the processing proceeds to step S1309. If the camera-shake state is determined to be “during panning” (DURING PANNING in step S1307), the processing proceeds to step S1310.

In step S1308, the priority changing unit 130 sets the weighting factors of the “tripod-fixed state” in weighting factors “ε2” according to the camera-shake state. In step S1309, the priority changing unit 130 sets the weighting factors of the “hand-held state” in the weighting factors “ε2” according to the camera-shake state. In step S1310, the priority changing unit 130 sets the weighting factors of “during panning” in the weighting factors “ε2” according to the camera-shake state.

In step S1311, the processing branches to step S1312 or S1313 according to the focal length determined by the position of the zooming lens 102. The camera microcomputer 114 can drive the zooming drive source 110 and perform a drive control on the zooming lens 102 to change the zooming position. The current position of the zooming lens 102 may be obtained based on the amount of zooming drive during the drive control. A position sensor (not illustrated) may be provided to obtain the position of the zooming lens 102 from the sensor output. In step S1311, if the focal length is determined to be on a “wide-angle side” with respect to a predetermined focal length (WIDE-ANGLE SIDE in step S1311), the processing proceeds to step S1312. If the focal length is determined to be on a “telephoto side” (TELEPHOTO SIDE in step S1311), the processing proceeds to step S1313. In step S1312, the priority changing unit 130 sets the weighting factors of the “wide-angle side” in weighting factors “ε3” according to the focal length. In step S1313, the priority changing unit 130 sets the weighting factors of the “telephoto side” in the weighting factors “ε3” according to the focal length.

In step S1314, the priority changing unit 130 multiplies the priorities “Priority” by the weighting factors “ε1” according to the imaging mode, the weighting factors “ε2” according to the camera-shake state, and the weighting factors “ε3” according to the focal length to calculate respective pieces of final priority information. Then, the processing proceeds to step S1315 to end the processing.

The method for calculating the priorities “Priority” in step S1314 may be replaced with an optimum method. For example, the priorities “Priority” may be multiplied by the sums of the respective weighting factors. The priorities “Priority” may be multiplies by only highest weighting factors among the respective weighting factors. In the present exemplary embodiment, the priority changing unit 130 changes the weighting of the priorities according to the imaging mode, the camera-shake mode, and the focal length. However, it is not limited thereto. For example, the priority changing unit 130 may change the weighting of the priorities “Priority” according to the exposure time (shutter speed) of the image sensor 106, according to whether in a zooming operation (zooming operation state), and according to the frame rate setting of the image capturing. The priority changing unit 130 may change the weighting of the priorities “Priority” according to at least one of the foregoing.

As described above, according to the present exemplary embodiment, the priorities of the respective categories are set based on the imaging frequencies calculated from image data captured in the past. The priorities are further changed according to the imaging condition of the video camera, such as the imaging mode and the camera-shake state. Consequently, the video camera can determine a more appropriate main object by dynamically taking account of the user's intention, and can adjust focus and exposure to the intended object without requiring complicated operations.

As described above, in the exemplary embodiments of the present invention, a captured image is divided into areas object by object based on features of the captured image, and the divided areas are classified by the types (categories) of the objects. A main object area is then determined in consideration of information about the centroid positions and sizes of the respective divided areas as well as information about the priorities of focusing attention as a main object according to the categories. Based on the main object area determined in such a manner, an evaluation area for obtaining an evaluation signal for an AF control and/or AE control is set. As a result, an object intended by the user can be automatically determined to be a main object and focus and exposure can be adjusted without requiring complicated operations.

Exemplary embodiments of the present invention are not limited to apparatuses of which a main purpose is to capture images, such as a digital camera, and may be applied to arbitrary apparatuses that include a built-in imaging apparatus or to which an imaging apparatus is externally connected. Examples include mobile phones, personal computers (including laptop, desktop, and tablet types), and game machines. As employed herein, an “imaging apparatus” is therefore intended to cover arbitrary electronic apparatuses having an imaging function.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-240992 filed Nov. 21, 2013, which is hereby incorporated by reference herein in its entirety.

What is claimed is:

1. An image processing apparatus comprising:
a selection unit configured to select a main object area from among a plurality of object areas of an image in which any one of a plurality of object types is assigned to each of the plurality of object areas;
a detection unit configured to detect a position and a size of each of the plurality of object areas; and
a setting unit configured to set an evaluation area for obtaining an evaluation signal used for a predetermined control based on the main object area selected by the selection unit,
wherein the selection unit is configured to select the main object area from among the plurality of object areas based on the position, size, and a priority set for each of the object types, of each of the plurality of object areas.

2. The image processing apparatus according to claim 1, wherein the selection unit is configured to select the main object area by giving a higher weight on the priority among the position, size, and the priority, of each of the plurality of object areas.

3. The image processing apparatus according to claim 1, wherein the selection unit is configured to calculate an evaluation value, which indicates a degree of certainty of the object area being a main object area, based on the position, size, and the priority, of each of the plurality of object areas, and select the main object area based on the evaluation value.

4. The image processing apparatus according to claim 3, wherein the selection unit is configured to increase the evaluation value as the position of the object area is closer to a center of the image.

5. The image processing apparatus according to claim 3, wherein the selection unit is configured to increase the evaluation value as the size of the object area increases.

6. The image processing apparatus according to claim 1, wherein the priority is set based on a feature amount including at least one of an object distance, contrast, and exposure corresponding to the object type.

7. The image processing apparatus according to claim 1,
wherein the plurality of object types includes persons, and
wherein the priority is set to be higher if the object type is a person than if the object type is not a person.

8. The image processing apparatus according to claim 1, further comprising a specification unit configured to accept a user's operation for specifying the priority of each of the object types,
wherein the priority specified by the user via the specification unit is set.

9. The image processing apparatus according to claim 1, further comprising a calculation unit configured to calculate an imaging frequency of each of the object types,
wherein the priority is set based on the imaging frequency calculated by the calculation unit.

10. The image processing apparatus according to claim 1, further comprising a changing unit configured to change the priority,
wherein the changing unit is configured to change the priority of each of the object types according to an imaging condition.

11. The image processing apparatus according to claim 10, wherein the imaging condition includes at least one of an imaging mode, a camera-shake state, a focal length, a shutter speed, a zooming operation state, and a frame rate.

12. The image processing apparatus according to claim 10,
wherein the imaging condition includes an imaging mode, and
wherein the changing unit is configured to change the priority of each of the object types according to an object type to which a high priority is given in a set imaging mode.

13. The image processing apparatus according to claim 10,
wherein the imaging condition includes a camera-shake state, and
wherein the changing unit is configured to, if the camera-shake state is in a first state, set the priority of a stationary object to be higher, and if the camera-shake state is in a second state higher than the first state, set the priority of a moving object to be higher.

14. The image processing apparatus according to claim 10,
wherein the imaging condition includes a focal length, and
wherein the changing unit is configured to change the priority of each of the object types according to an object type estimated based on the focal length.

15. The image processing apparatus according to claim 1, wherein the setting unit is configured to set an evaluation area for obtaining an evaluation signal used for a control including at least one of a focus adjustment control, an exposure adjustment control, and a color adjustment control based on the selected main object area.

16. An imaging apparatus comprising:
the image processing apparatus according to claim 1; and
an imaging unit configured to photoelectrically convert an optical image to generate the image.

17. A method for controlling an image processing apparatus, the method comprising:
selecting a main object area from among a plurality of object areas of an image in which any one of a plurality of object types is assigned to each of the object areas;
detecting a position and a size of each of the plurality of object areas; and
setting an evaluation area for obtaining an evaluation signal used for a predetermined control based on the selected main object area,
wherein the main object area is selected from among the object areas based on the position, size, and a priority set for each of the object types, of each of the plurality of object areas.

18. A non-transitory storage medium storing a program that causes a computer to perform the method for controlling an image processing apparatus according to claim 17.
